(19) United States
(12) Patent Application Publication
(10) Pub. No.: US 2008/0307387 A1
(43) Pub. Date: Dec. 11, 2008

(54) SOFTWARE DEVELOPMENT APPARATUS AND METHOD FOR PROVIDING PERFORMANCE PREDICTION

(76) Inventors: Seok Jin Yoon, Daejeon (KR); Gyu Sang Shin, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/950,042

(22) Filed: Dec. 4, 2007

(30) Foreign Application Priority Data
Dec. 5, 2006 (KR) 10-2006-0122286
Sep. 10, 2007 (KR) 10-2007-0091291

(51) Int. Cl. G06F 9/44; G06F 17/00

(52) U.S. Cl. 717/110; 707/104.1; 707/E17.001

(57) ABSTRACT

Provided are an apparatus and method for developing software. More particularly, provided are a software development apparatus and method enabling prediction of non-functional performance, such as execution time, as well as functional performance of each constituent module in a software development process.

The apparatus includes: an Application Programming Interface (API) performance index database (DB) for storing performance information on APIs; a performance DB constructor for separately executing APIs used in a source code of a module to measure performance, and storing performance information on the respective APIs in the API performance index DB; an editor for editing the source code of the module and displaying performance of the module; and a code performance analyzer for receiving the source code of the module from the editor, calculating the performance of the module with reference to the API performance index DB, and providing the calculation result to the editor.

The apparatus and method allow a developer to readily predict performance of an under-writing module of under-development software and write a code complying with required performance.

### CROSS-REFERENCE TO RELATED APPLICATION

This application claims priority to and the benefit of Korean Patent Application No. 2006-122286, filed Dec. 5, 2006, and No. 2007-91291, filed Sep. 10, 2007, the disclosure of which is incorporated herein by reference in its entirety.

### BACKGROUND

1. Field of the Invention

The present invention relates to an apparatus and method for developing software, and more particularly, to a software development apparatus and method enabling prediction of non-functional performance, such as execution time, as well as functional performance of each constituent module in a software development process.

2. Discussion of Related Art

In a software development process, a developer analyzes requests of a client to analyze functions to develop, classifies the functions to define modules, and codes each module using a programming language, such as Java, C, C++, etc., thereby developing software. Meanwhile, while coding a module, a developer generally inserts an Application Programming Interface (API) in his/her code and calls the API. Since the API generally provides functional details only, the developer cannot obtain information on execution time required for actually using the API. Execution performance of the module developed by the developer can be tested by only directly executing the module after software coding is completed. Here, when a function is not properly performed or a desired execution speed is not achieved by the developed program, the developer repeats the process of modifying a source code coded using a programming language (or a user language), rewriting the software, compiling and executing the software again, and thereby checking the result.

The reason why it is determined whether or not software is mal-developed via a testing operation after software implementation is completed is that the concept of execution time is not properly applied to a software development process or is overlooked. As a result, development time is delayed, development cost increases, and so on.

### SUMMARY OF THE INVENTION

The present invention is directed to a software development apparatus and method providing a function of predicting non-functional performance, the software development apparatus and method displaying time performance of each used Application Programming Interface (API) in number to enable a developer to better predict the performance of software in a software development process, and enabling the developer to develop appropriate software for the performance of hardware, in which the software will operate, using a concept of hardware-neutral time.

One aspect of the present invention provides an apparatus for developing software, comprising: an API performance index database (DB) for storing performance information on APIs; a performance DB constructor for separately executing APIs used in a source code of a module to measure performance, and storing performance information on the respective APIs in the API performance index DB; an editor for editing the source code of the module and displaying performance of the module; and a code performance analyzer for receiving the source code of the module from the editor, calculating the performance of the module with reference to the API performance index DB, and providing the calculation result to the editor.

Another aspect of the present invention provides an apparatus for developing software, comprising: an editor for editing a source code of a module and displaying performance information on an API used in the source code and performance of the module calculated on the basis of the performance information; an API performance index DB for storing, in hardware-neutral number, time-performance information on all APIs provided by a library and an operating system; and a code performance analyzer for receiving the source code of the module from the editor, reading performance information on respective APIs used in the module with reference to the API performance index DB, calculating performance of the module on the basis of the performance information, and providing the calculation result to the editor. Still another aspect of the present invention provides a method of developing software, comprising the steps of: (a) receiving a source code of a module and reading names of APIs in the module; (b) separately executing the read APIs to measure their performance, and recording the performance information on the respective APIs to construct a performance index DB; (c) calculating performance of the module using the performance information on the respective APIs recorded in the performance index DB on the basis of the names of the APIs; and (d) displaying the performance of the module calculated in step (c).

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a block diagram of a software development apparatus providing a performance prediction function according to an exemplary embodiment of the present invention;

FIG. 2 is a flowchart showing operation of a code performance analyzer according to an exemplary embodiment of the present invention;

FIG. 3 is a flowchart showing operation of a performance database constructor according to an exemplary embodiment of the present invention; and

FIG. 4 illustrates a code editor providing performance details according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention.

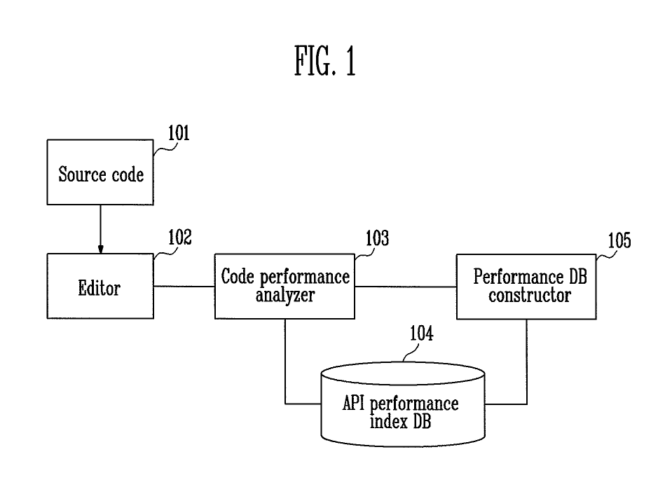

FIG. 1 is a block diagram of a software development apparatus providing a function of predicting non-functional performance according to an exemplary embodiment of the present invention.

As illustrated in FIG. 1, the software development apparatus providing a function of predicting non-functional performance comprises a source code editor 102, a code performance analyzer 103, an Application Programming Interface (API) performance index database (DB) 104 and a performance DB constructor 105.

Here, the editor 102 provides a general editor function of editing a source code, and displays performance of each module calculated by a code analyzer to a developer. The code performance analyzer 103 receives the source code of a module, calculates performance, i.e., predicted execution time, of the whole module with reference to the API performance index DB 104, and provides the calculation result to the editor 102. In FIG. 1, the code performance analyzer 103 is illustrated separately from the editor 102, but may be implemented as a part of the editor 102. Also, the code performance analyzer 103 can be composed of software, hardware or firmware. The API performance index DB 104 stores performance information on APIs. The API performance information stored in the API performance index DB 104 may be a set of performance information on the measured result. In this case, the code performance analyzer 103 calls the performance DB constructor 105 on the basis of the names of APIs read from the source code, and the performance DB constructor 105 measures execution time of the APIs in real time. Otherwise, the API performance information stored in the API performance index DB 104 may be previously stored performance information on all APIs provided by a library and an operating system. The performance DB constructor 105 executes an API of a library to use to measure Worst Case Execution Time (WCET), and stores the WCET in the API performance index DB 104.

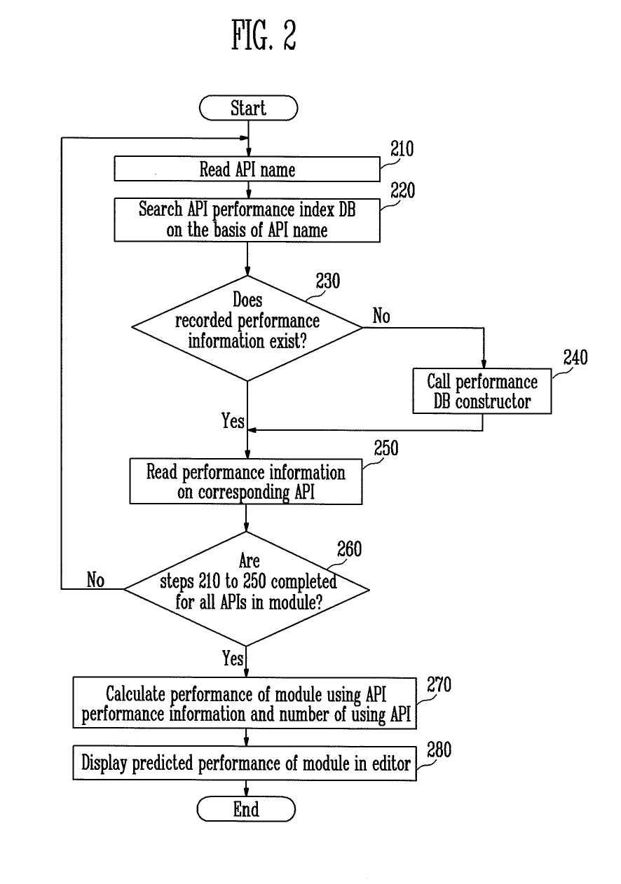

FIG. 2 is a flowchart showing operation of the code performance analyzer 103 according to an exemplary embodiment of the present invention.

As illustrated in FIG. 2, first, a name of an API used in each module of a source code is read with reference to an existing API DB provided by a system (step 210). Subsequently, the API performance index DB 104 is searched on the basis of the API name (step 220), and it is determined whether recorded performance information exists (step 230). When previously stored performance information exists, it is read. On the contrary, when previously stored performance information does not exist, the performance DB constructor 105 is called to construct a performance index DB on the API (step 240). Steps 210 to 250 are repeated for all the APIs in the corresponding module. When steps 210 to 250 are completed for all the APIs, overall performance of the module is calculated on the basis of the number of using respective APIs and performance information on the respective APIs (step 270), and the overall performance is provided to the editor 102 (step 280).

Otherwise, although not shown in the drawings, the code performance analyzer 103 can operate using the performance index DB 104 already storing performance information on all the APIs provided by a library and an operating system without calling the performance DB constructor 105. In this case, the code performance analyzer 103 makes a list of APIs that the corresponding module uses, searches the performance index DB 104, and calculates performance information on the APIs in the module, thereby calculating the overall performance of the module.

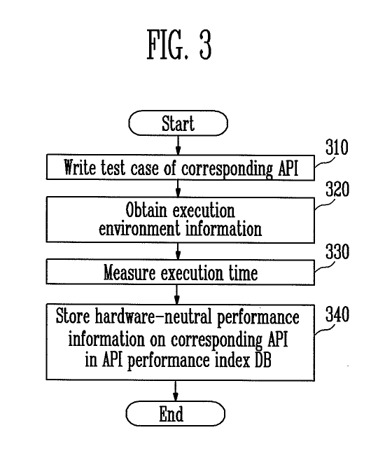

FIG. 3 is a flowchart showing operation of the performance DB constructor 105 according to an exemplary embodiment of the present invention.

As illustrated in FIG. 3, the performance DB constructor 105 writes a test case of the corresponding API (step 310). Subsequently, the performance DB constructor 105 obtains environmental information on hardware in which the test case will be performed (step 320), executes the API of a library to be used in order to measure WCET (step 330), and stores the WCET in the API performance index DB 104 (step 340). Since actual execution time of software generally varies according to performance of an executing central processing unit (CPU), a neutral index like execution time/CPU performance is made, and an index value is stored.

Otherwise, although not shown in the drawings, the performance DB constructor 105 may independently operate without a call from the code performance analyzer 103. In this case, respective test cases are written for all the APIs provided by an existing library and operating system, the test cases are performed to measure WCET, and the WCET is stored in the API performance index DB 104. Consequently, performance information on all the APIs provided by the library and operating system is previously stored in the API performance index DB 104.

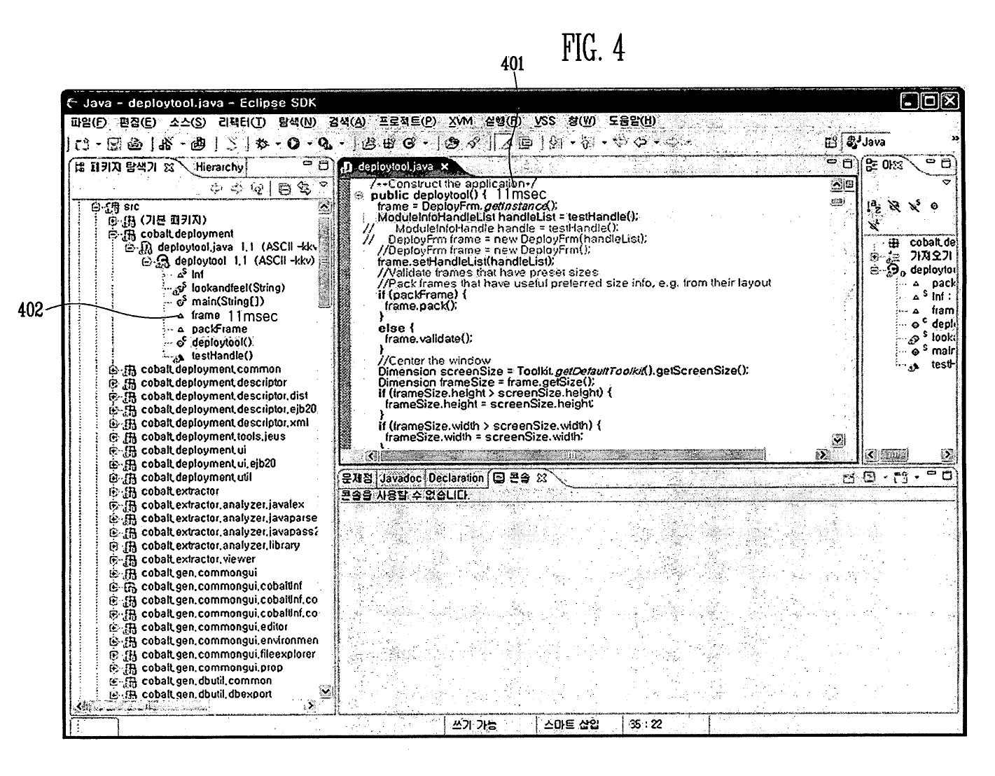

FIG. 4 illustrates the editor 102 according to an exemplary embodiment of the present invention.

Using the editor 102 as shown in FIG. 4, a developer can predict performance of an under-writing module without compiling and executing the module. The editor 102 displays a result calculated by the code performance analyzer 103 as an exemplary embodiment of the present invention, in an editing area of the module as shown in FIG. 4. An item related to execution time is added to an “attribute” field describing an individual API and display time-performance information on respective APIs.

As described above, the software development apparatus and method providing a function of predicting non-functional performance according to the present invention analyze performance of the corresponding module using performance information on APIs used by a code and performance analysis information on the code itself, and display the information in an editor during a development process, thereby allowing a developer to check the performance of the under-writing code without actually executing the code. Therefore, it is possible to write a code complying with required performance.

In addition, the software development apparatus and method use the concept of hardware-neutral time to enable development of appropriate software for performance of hardware in which the software operates.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for developing software, comprising:
an Application Programming Interface (API) performance index database (DB) for storing performance information on APIs;
a performance DB constructor for separately executing APIs used in a source code of a module to measure performance, and storing performance information on the respective APIs in the API performance index DB;
an editor for editing the source code of the module and displaying performance of the module; and
a code performance analyzer for receiving the source code of the module from the editor, calculating the performance of the module with reference to the API performance index DB, and providing the calculation result to the editor.

2. The apparatus of claim 1, wherein the editor adds an item related to execution time to an “attribute” field describing an individual API, and displays time-performance information on the respective APIs and time performance of the module in detail.

3. The apparatus of claim 1, wherein the performance DB constructor writes and performs a test case for the respective APIs.

4. The apparatus of claim 3, wherein the time-performance information on the respective APIs is Worst Case Execution Time (WCET).

5. The apparatus of claim 4, wherein the time-performance information on the respective APIs is displayed in hardware-neutral number.

6. An apparatus for developing software, comprising:
an editor for editing a source code of a module and displaying performance information on an Application Programming Interface (API) used in the source code and performance of the module calculated on the basis of the performance information;
an API performance index database (DB) for storing, in hardware-neutral number, time-performance information on all APIs provided by a library and an operating system; and
a code performance analyzer for receiving the source code of the module from the editor, reading performance information on respective APIs used in the module with reference to the API performance index DB, calculating performance of the module on the basis of the performance information, and providing the calculation result to the editor.

7. The apparatus of claim 6, wherein the editor adds an item related to execution time to an “attribute” field describing an individual API, and displays time-performance information on the respective APIs and time performance of the module in detail.

8. The apparatus of claim 6, wherein the code performance analyzer makes a list of the APIs used in the module.

9. The apparatus of claim 8, wherein performance information on all the APIs provided by the library and the operating system is previously stored in the API performance index DB.

10. The apparatus of claim 9, wherein the time-performance information on the respective APIs is Worst Case Execution Time (WCET).

11. A method of developing software, comprising the steps of:
(a) receiving a source code of a module and reading names of APIs in the module;
(b) separately executing the read APIs to measure their performance, and recording the performance information on the respective APIs to construct a performance index database (DB);
(c) calculating performance of the module using the performance information on the respective APIs recorded in the performance index DB on the basis of the names of the APIs; and
(d) displaying the performance of the module calculated in step (c).

12. The method of claim 11, wherein step (b) comprises the steps of:
writing a test case of a corresponding API;
obtaining execution-environment information;
measuring an execution time; and
storing performance information on the corresponding API.

13. The method of claim 11, wherein step (c) further comprises the step of:
repeating step (a) and step (b) for all the APIs in the module,
and the performance of the module is calculated using the performance information on the respective APIs and a number of using the respective APIs.

14. The method of claim 13, wherein in step (d), an item related to execution time is added to an “attribute” field, and time-performance information on the respective APIs and the performance of the module are displayed in hardware-neutral number.
